(19) United States
(12) Patent Application Publication
(10) Pub. No.: US 2013/0037639 A1
(43) Pub. Date: Feb. 14, 2013

(54) WASTE BIN LEVELING SYSTEM FOR A PAPER SHREDDER

(71) Applicants: Guanlong Chen, Shanghai (CN); Yung Kang Tso, Shanghai (CN); Kevin Chen, Rancho Palos Verdes, CA (US); Chung Shih Tsai, Hawthorne, CA (US)

(72) Inventors: Guanlong Chen, Shanghai (CN); Yung Kang Tso, Shanghai (CN); Kevin Chen, Rancho Palos Verdes, CA (US); Chung Shih Tsai, Hawthorne, CA (US)

(73) Assignee: Aurora Office Equipment Co., Ltd. Shanghai, Shanghai (CN)

(21) Appl. No.: 13/205,504

(22) Filed: Aug. 8, 2011

(51) Int. Cl. B02C 11/08

(52) U.S. Cl. 241/47

(57) ABSTRACT

A paper shredder having a ventilation fan; a ventilation duct tightly coupled to the ventilation fan; and air openings on the ventilation duct to blow air so that the natural fall of paper waste is disturbed. The air openings are on the ventilation duct blow air generally sideways or generally angularly to the natural fall of paper waste. The ventilation fan intake is proximate to and provides supplemental cooling air flow to, a shredder motor. A lower lid is generally above the waste bin, wherein the air openings are disposed to blow air. The shredder motor is on the lower lid. A ventilation fan intake is proximate to a shredder motor and tightly coupled to the ventilation fan, the ventilation fan intake provides supplemental cooling air flow to the shredder motor, and the air openings are on the ventilation duct blow air angularly to the natural paper waste fall.

### BACKGROUND

1. Field of the Invention

The present embodiments relate to the field of paper shredders, and more particularly to paper shredder waste bin leveler.

2. Background Art

In paper shredders, inefficient waste paper accumulation causes indications of a full waste bin when, in fact, the waste bin is not empty. This result originates in the tendency of the just-comminuted shreddant waste to accumulate with a peaked, or conically-shaped heap. In some shredders, the comminuted waste paper may even back-up in the shredder blades, adding stress to the motorized blades, significantly shortening their service lives. Also, other existing paper shredders use a mechanical blade or mechanical plate to press down on the waste shreddant in an attempt to level the waste. Still other existing paper shredders use mechanical sweeping blades to prevent piling up of waste shreddant, to avoid a false indication of a full paper bin. At times, the shreddant waste or dust accumulates within these leveling mechanisms causing them to malfunction or to fail. An apparatus to prevent waste bin inefficiency is needed.

### SUMMARY

The present embodiments include a paper shredder, comminuting paper into paper waste, which has a ventilation fan; a ventilation duct tightly coupled to the ventilation fan; and a plurality of air openings disposed on the ventilation duct to blow air so that the natural fall of paper waste is disturbed. In some embodiments the plurality of air openings are disposed on the ventilation duct to blow air generally sideways to the natural fall of paper waste. In other embodiments, wherein the plurality of air openings are disposed on the ventilation duct to blow air generally angularly to the natural fall of paper waste. In selected embodiments a ventilation fan intake is disposed proximate to a shredder motor, and wherein the ventilation fan intake provides supplemental cooling air flow to the shredder motor. The paper shredder also may include a lower lid disposed generally above a waste bin, wherein the plurality of air openings are disposed to blow air so that the natural accumulation of paper waste is disturbed.

In some selected embodiments the shredder motor is disposed on the lower lid, wherein a ventilation fan intake is disposed proximate to a shredder motor and tightly coupled to the ventilation fan, wherein the ventilation fan intake provides supplemental cooling air flow path to the shredder motor, and wherein the plurality of air openings are disposed on the ventilation duct to blow air generally angularly to the natural fall of paper waste.

In another embodiment, a paper shredder providing waste paper is set forth, including a shredder waste bin to receive the waste paper; a lower lid configured resting atop the shredder waste bin and configured to allow waste paper to fall into the shredder waste bin; a ventilation fan disposed on the lower lid; a ventilation duct tightly coupled to the ventilation fan; and a plurality of air openings disposed on the ventilation duct to blow air so that the natural fall of waste paper is disturbed. In addition, the shredder can have motorized shredder blades disposed on the lower lid and configured to receive and comminute to waste paper, wherein the ventilation fan intake is positioned proximate to the motorized shredder blades, so that ventilation fan intake provides cooling to the motorized shredder blades when the ventilation fan is operating.

### BRIEF DESCRIPTION OF THE EMBODIMENTS

Embodiments of the present invention disclosed herein are illustrated by way of example, and are not limited by the accompanying figures, in which like references indicate similar elements, and in which:

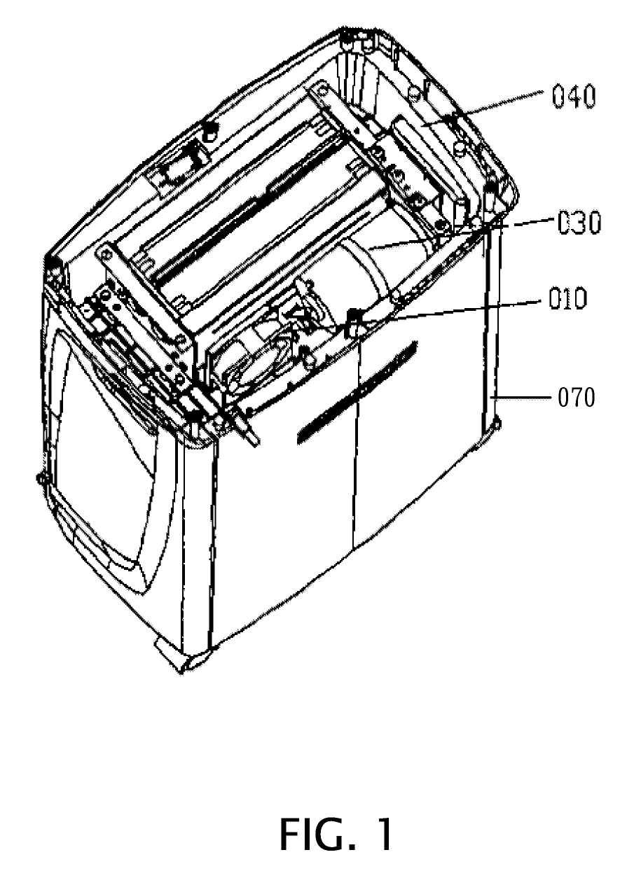

FIG. 1 is a perspective view of a paper shredder waste bin leveler embodiment, in accordance with the teachings of the present invention;

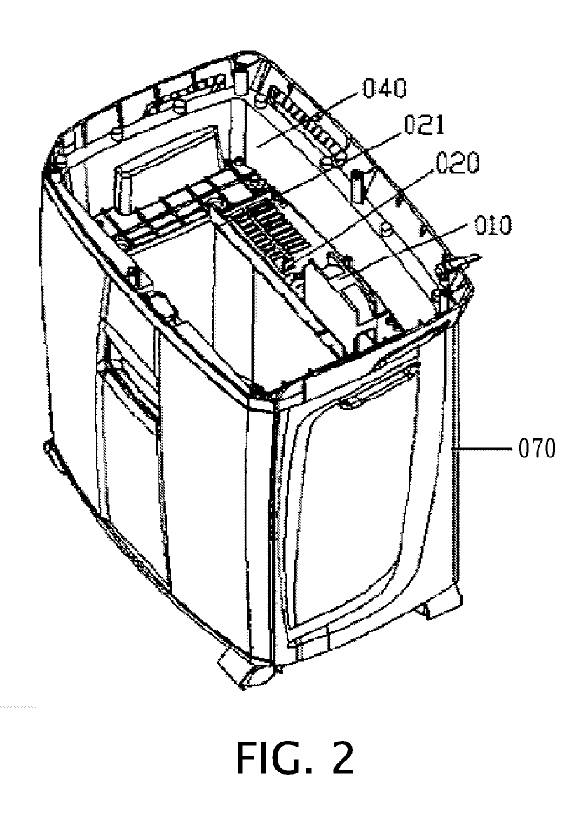

FIG. 2 is another perspective view of a paper shredder waste bin leveler embodiment, in accordance with the teachings of the present invention;

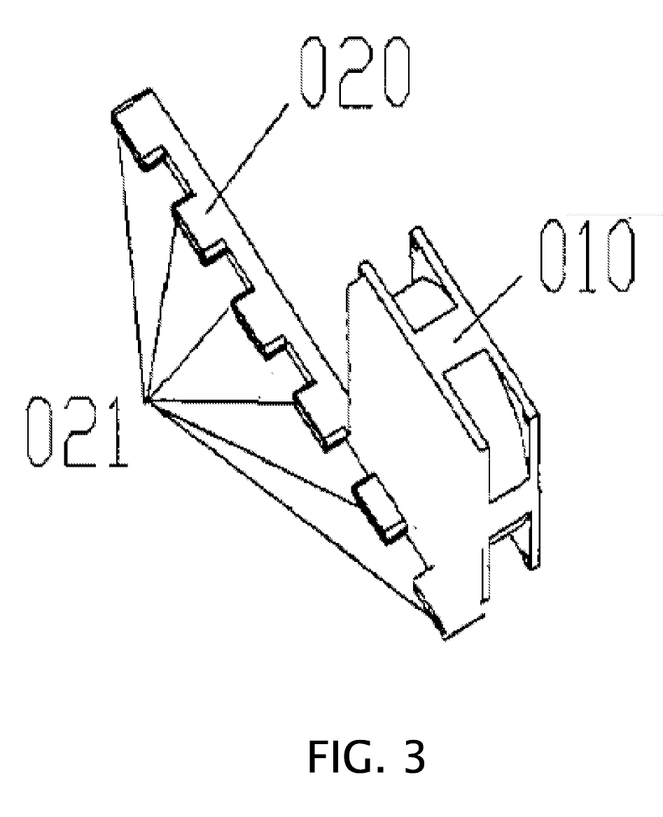

FIG. 3 is a perspective view of a fan, ventilation ducts, and ventilation openings, in accordance with the teachings of the present invention;

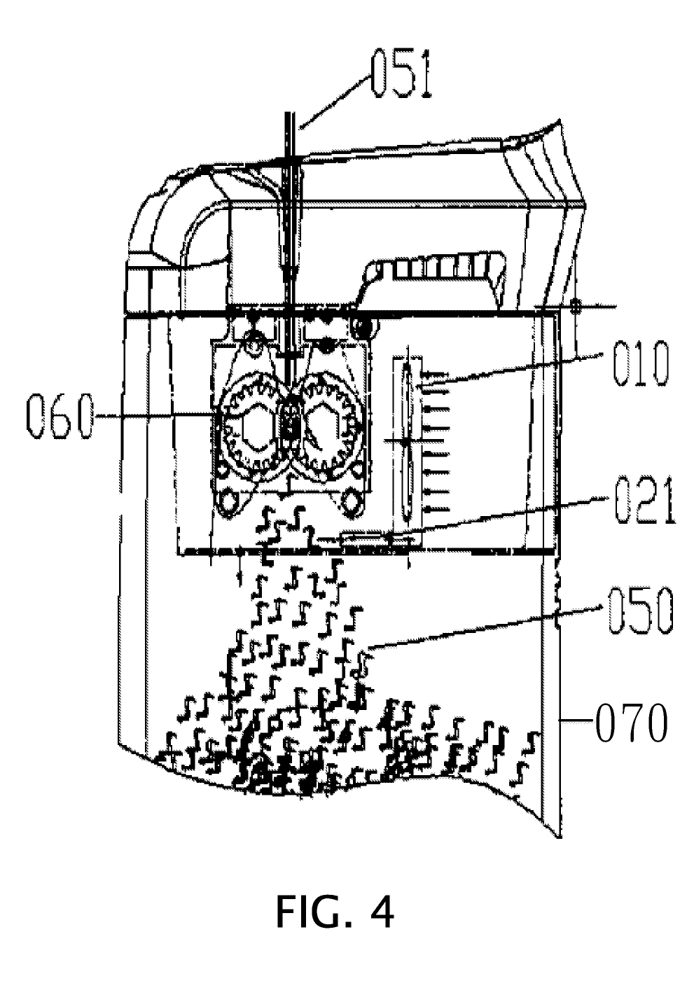

FIG. 4 is a cross-section view of a paper shredder having a waste bin leveler embodiment, in accordance with the teachings of the present invention; and

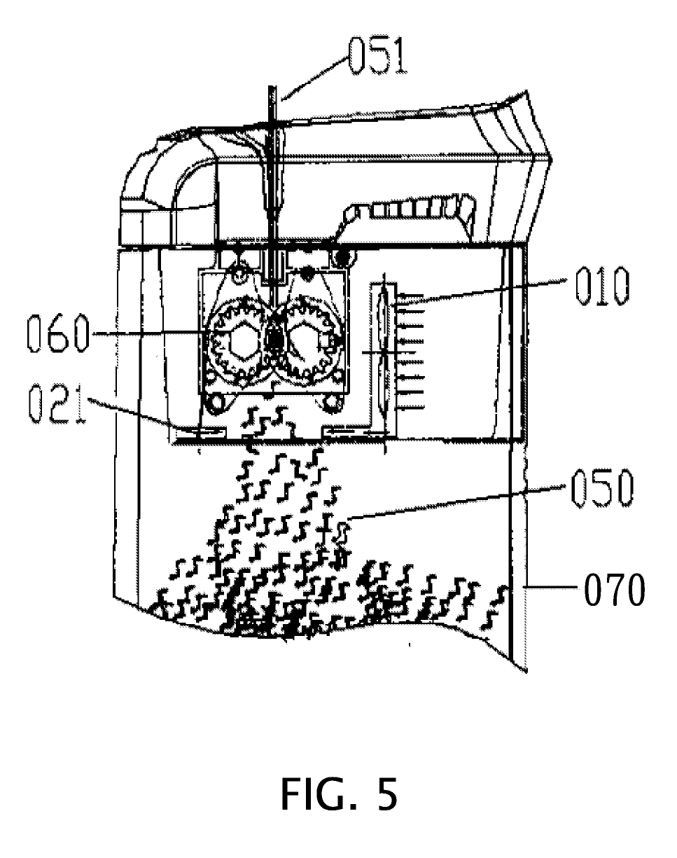

FIG. 5 is a cross-section view of a paper shredder having another waste bin leveler embodiment, in accordance with the teachings of the present invention.

Skilled artisans can appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE EMBODIMENTS

Turning to FIGS. 1 and 2, waste bin leveling system 100 includes, without limitation, a waste bin fan 010, a ventilation duct 020 coupled to fan 010, and air outlets 021, providing exhaust outflow streams from ventilation duct 020. System 100 may be disposed atop shredder waste bin 070. Typically, fan 010 can be disposed at one end of shredder motor 030. Fan 010 may be operated with air flow being directed away from motor. This aspect may assist in providing additional cooling, reliability, and longevity for motor 030. Ventilation duct 020 may have at least two ends, with one end being tightly coupled to motor 030 and at least one other end opening into air outlets 021. In general, air outlets 021 are arranged to be in a side-by-side configuration, although other configurations may be used for example, that seen in FIG. 3. In this configuration, air ducts 021 can be disposed generally peripherally relative to lower lid 040, creating a plurality of outflow streams blowing air generally uniformly from the lower lid 040 of the paper shredder wastebin 070 onto the shreddant waste (not shown). In FIG. 2, the general locations of fan 010, duct 020, and outlets 021 may be seen from the vantage which otherwise may be hidden by the shredder blades 060 (e.g., FIG. 4).

In another example embodiment, system 200, shown in FIG. 4, depicts a stack of shreddant 051, such as paper, being comminuted by shredder blades 060 into shreddant waste 050. Fan 010 can generate an air outflow, which becomes outflow streams emanating from outlets 021. The outflow streams impinge upon shreddant waste 050, so that waste 050 tends not to fall directly under blades 060 and falls dispersedly to be more evenly distributed within waste bin 070. A more even, and leveled, use of waste bin 070 space tends to reduce erroneous “paper full” indications, thereby increasing usage efficiency and convenience to the user. In FIG. 4, air is blown from air ducts 021 downward towards shreddant waste 050.

FIG. 5 illustrates another example embodiment of system 300, which can be similar to aforementioned systems 100 and 200. In system 300, blades 060 tend to be disposed more towards one side of lower lid 040, allowing ventilation duct 020 to be extended and air outlets 021 be distributed as seen in FIG. 5. In such a configuration ventilation duct 020 and outlets 021 may be configured in plural ways, as would be understood by a person having ordinary skill in the art upon appreciating the teachings provided herein. IN FIG. 5, air openings 021 are disposed be generally blowing air perpendicular to the direction of fall of shreddant waste 50. Such side-to-side air flows tend to oppose the building up of waste 50 as a peaked or heaped-shaped structure.

The embodiments of the present invention disclosed herein are intended to be illustrative only, and are not intended to limit the scope of the invention. It should be understood by those skilled in the art that various modifications and adaptations of the prevent invention as well as alternative embodiments of the prevent invention may be contemplated or foreseeable. It is to be understood that the present invention is not limited to the sole embodiments described above, but encompasses any and all embodiments within the scope of the following claims.

1. A paper shredder, comminuting paper into paper waste, comprising:
a ventilation fan;
a ventilation duct tightly coupled to the ventilation fan; and
a plurality of air openings disposed on the ventilation duct to blow air so that the natural fall of paper waste is disturbed.

2. The paper shredder of claim 1, wherein the plurality of air openings are disposed on the ventilation duct to blow air generally sideways to the natural fall of paper waste.

3. The paper shredder of claim 1, wherein the plurality of air openings are disposed on the ventilation duct to blow air generally angularly to the natural fall of paper waste.

4. The paper shredder of claim 1, wherein a ventilation fan intake is disposed proximate to a shredder motor, and wherein the ventilation fan intake provides supplemental cooling air flow to the shredder motor.

5. The paper shredder of claim 1, further comprising lower lid disposed generally above a waste bin, wherein the plurality of air openings are disposed to blow air so that the natural accumulation of paper waste is disturbed.

6. The paper shredder of claim 5, wherein a shredder motor is disposed on the lower lid, wherein a ventilation fan intake is disposed proximate to a shredder motor and tightly coupled to the ventilation fan, wherein the ventilation fan intake provides supplemental cooling air flow path to the shredder motor, and wherein the plurality of air openings are disposed on the ventilation duct to blow air generally angularly to the natural fall of paper waste.

7. A paper shredder providing waste paper, comprising:
a shredder waste bin to receive the waste paper;
a lower lid configured to allow waste paper to fall into the shredder waste bin;
a ventilation fan disposed on the lower lid;
a ventilation duct tightly coupled to the ventilation fan; and
a plurality of air openings disposed on the ventilation duct to blow air so that the natural fall of waste paper is disturbed.

8. The paper shredder of claim 7, further comprising:
motorized shredder blades disposed on the lower lid and configured to receive and comminute to waste paper, wherein the ventilation fan intake is positioned proximate to the motorized shredder blades, so that ventilation fan intake provides cooling to the motorized shredder blades when the ventilation fan is operating.
